(19) United States
(12) Patent Application Publication
(10) Pub. No.: US 2025/0375858 A1
(43) Pub. Date: Dec. 11, 2025

(54) RATCHET WRENCH ASSEMBLY

(71) Applicants: Yi-Fu Chen, Taichung City (TW); He-Qian Chen, Taichung City (TW)

(72) Inventors: Yi-Fu Chen, Taichung City (TW); He-Qian Chen, Taichung City (TW)

(21) Appl. No.: 18/735,132

(22) Filed: Jun. 5, 2024

(51) Int. Cl. B25B 13/46

(52) U.S. Cl. CPC B25B 13/461

(57) ABSTRACT

A ratchet wrench assembly includes a ratchet installed in a through hole of a head. The ratchet includes a through hole, an annular groove and a side opening. The through hole communicates with the annular groove via the side opening. One of two open ends of the through hole is a star-shaped opening with twelve points. Another one of the two open ends of the through hole is a hexagonal opening with six points. A C-clip is secured in the annular groove. A part of the C-clip located at the side opening is located inside the through hole. A working component has a hexagonal cross section and is inserted from the star-shaped opening end. When the working component matches with the hexagonal opening, it is movable through the through hole. When the working component is not matched with the hexagonal opening, the rod part cannot pass through the through hole.

### BACKGROUND OF THE INVENTION

### 1. Fields of the Invention

The present invention relates to a hand tool, and more particularly, to a ratchet wrench assembly used for tightening and loosening target objects (e.g., screws).

### 2. Descriptions of Related Art

The A wrench is a very common hand tool and generally used for loosening or tightening screws and nuts. The commonly seen open-end wrench requires a relatively large operating space to be used smoothly and continuously. In a confined space, the wrench needs to be removed after a slight turn due to environmental limitations, then reattached to the screw for another turn, which is quite time-consuming. Therefore, some tool manufacturers develop ratchet wrenches, allowing users to continuously turn without removing the wrench from the screw, making it very convenient to use in tight spaces.

Currently, there are many types of wrenches available on the market for users to choose from according to different situations. For instance, ratchet wrenches that can quickly operate back and forth in narrow spaces, socket extension wrenches used for deeper construction points, and T-handle wrenches used when greater force is needed. However, because of this variety, construction workers often need to carry various types of wrenches, leading to the issue of excessive weight burden from carrying these tools.

Given the aforementioned problems, it is quite necessary to reduce the weight burden of carrying wrenches for construction workers.

The present invention intends to provide a ratchet wrench assembly to eliminate the shortcomings mentioned above.

### SUMMARY OF THE INVENTION

The present invention relates to a ratchet wrench assembly and comprises a wrench having a head and a working part respectively formed to two ends thereof. A ratchet is installed within the head of the wrench, and includes a through hole, an annular groove and a side opening. The side opening is defined in an inner bottom the annular groove. The through hole communicates with the annular groove via the side opening. One of two open ends of the through hole is a star-shaped opening with twelve points, each angle spaced 30 degrees apart. Another one of the two open ends of the through hole is a hexagonal opening with six points, each angle spaced 60 degrees apart. The hexagonal opening is located corresponding to the star-shaped opening. A C-clip is engaged with the annular groove. A part of the C-clip located in the side opening is located inside the through hole. A working component includes a rod part and a working head. A cross section of the rod part is hexagonal. When the rod part matches with the hexagonal opening. The rod part is movable through the through hole. When the rod part is inserted into the through hole and is not matched with the hexagonal opening, the rod part cannot pass through the through hole.

The present invention utilizes the structural design of a through hole with a twelve-point star-shaped opening and a hexagonal opening. When a working component with a hexagonal rod part is inserted from the star-shaped opening, when the rod part is matched with the hexagonal opening, it can pass through the through hole, thus forming a T-shaped wrench. When the rod part is rotated 30 degrees, and the rod part enters from the star-shaped opening but cannot pass through the hexagonal opening of the through hole. In this state, the invention functions as a socket extension wrench.

From the above, it is clear that by simply switching the combination mode of the invention and the working component, the wrench type can be switched, thereby reducing the total weight of wrenches that construction workers need to carry. This invention effectively addresses the common problem of excessive weight that construction workers have to bear when carrying wrenches, and it indeed has novelty and progressiveness.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is an exploded view of the present invention;

FIG. 3 is a cross-sectional view, taken along line III-III of FIG. 1;

FIG. 4 is a plan view of the present invention;

FIG. 5 illustrates that the rod part of the working component passes through the through hole;

FIG. 6 is a cross-sectional view, taken along line VI-VI of FIG. 5, and

FIG. 7 shows that the rod part is inserted into the star-shaped opening but unable to pass through the through hole.

### DETAILED DESCRIPTION OF THE PREFERRED EMBODIMENT

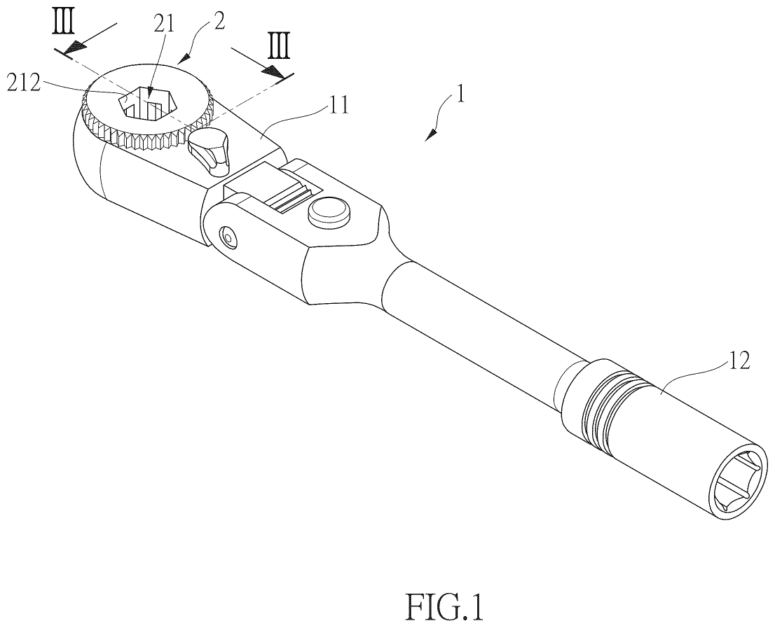

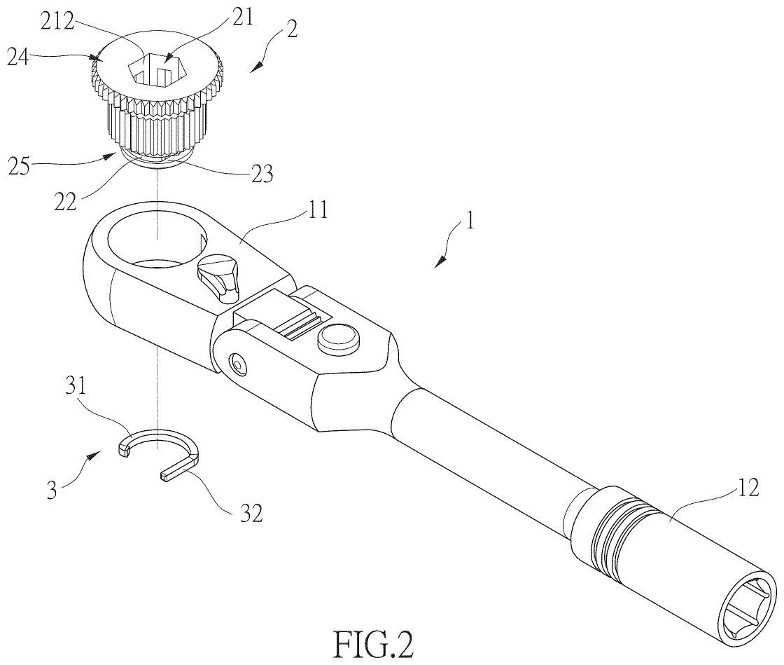

Referring to FIGS. 1 to 9, the ratchet wrench assembly of the present invention comprises a wrench (1) having a head (11) and a working part (12) respectively formed to two ends thereof. A ratchet (2) is installed within the head (11) of the wrench (1), and includes a through hole (21), an annular groove (22) and a side opening (23), the side opening (23) defined in an inner bottom the annular groove (22). The through hole (21) communicates with the annular groove (22) via the side opening (23). One of two open ends of the through hole (21) is a star-shaped opening (211) with twelve points, each angle spaced 30 degrees apart. Another one of the two open ends of the through hole (21) is a hexagonal opening (212) with six points, each angle spaced 60 degrees apart. The hexagonal opening (212) is located corresponding to the star-shaped opening (211). A C-clip (3) is engaged with the annular groove (22). A part of the C-clip (3) located in the side opening (23) is located inside the through hole (21).

A working component (4) includes a rod part (41) and a working head (42). A cross section of the rod part (41) is hexagonal. When the rod part (41) matches with the hexagonal opening (212), the rod part (41) is movable through the through hole (21), so that the ratchet wrench assembly forms a T-shaped wrench. When the rod part (41) is inserted into the through hole (21) and is not matched with the hexagonal opening (212), the rod part (41) cannot pass through the through hole (21). Specifically, when the rod part (41) is rotated 30 degrees, and the rod part (41) enters from the star-shaped opening (211) but cannot pass through the hexagonal opening (212) of the through hole (21), the ratchet wrench assembly functions as a socket extension wrench.

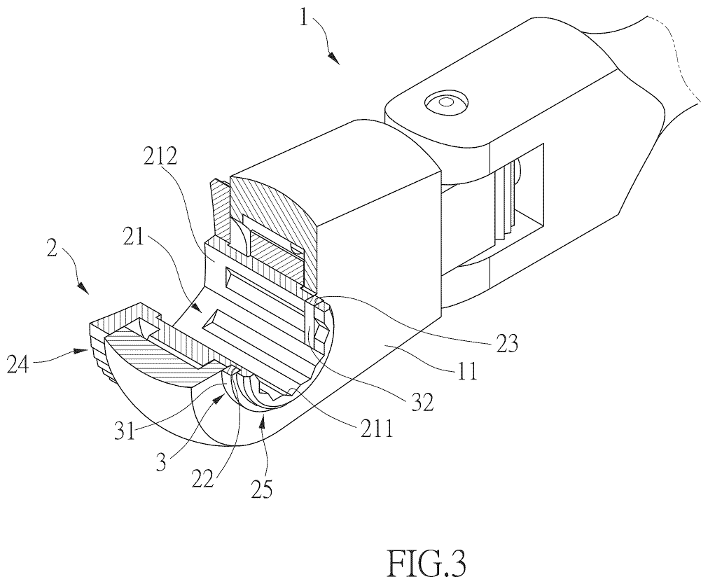

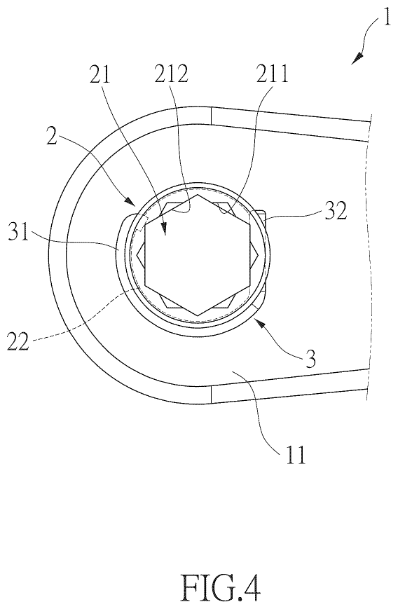

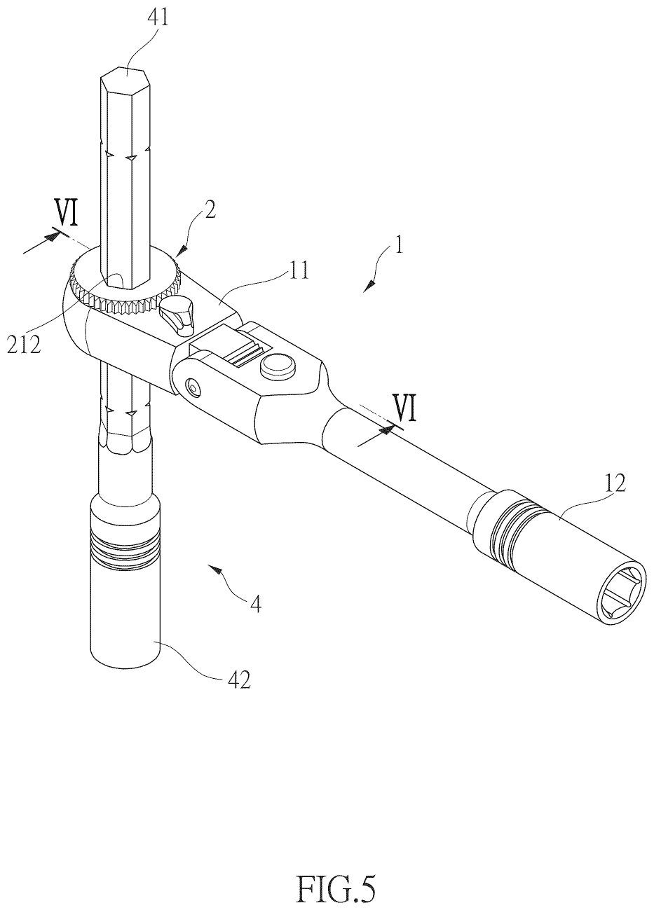

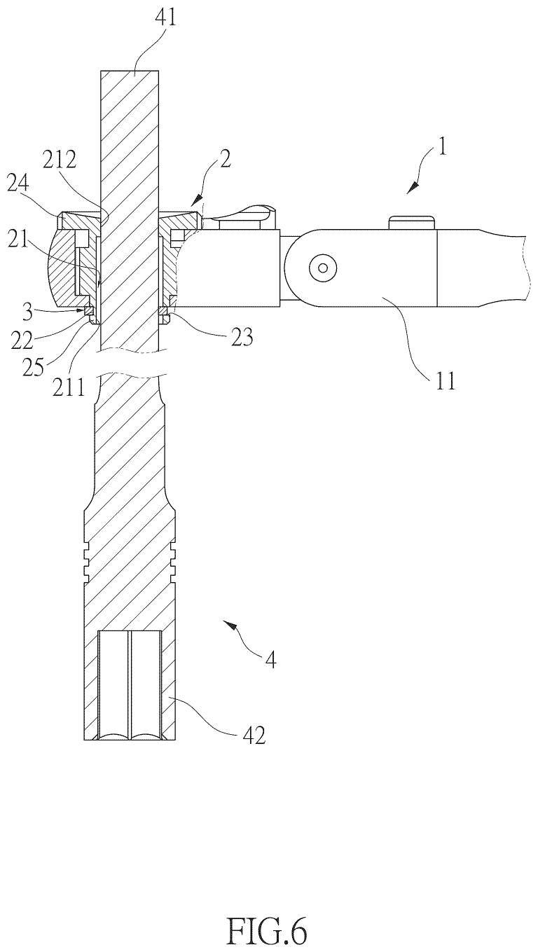

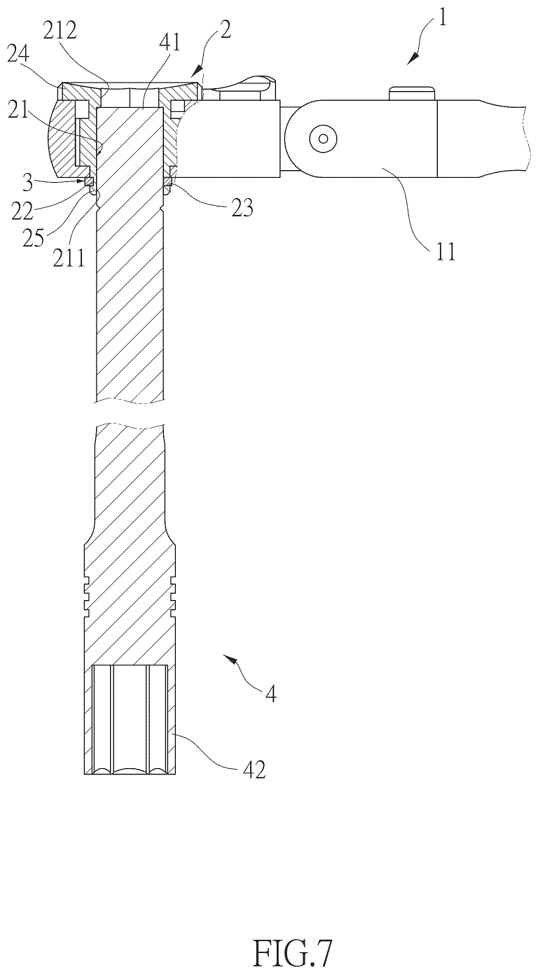

From the above content and as shown in FIGS. 3 and 4, it can be understood that the present invention utilizes the structural design of the through hole (21), which includes a twelve-point star-shaped opening (211) and a hexagonal opening (212). This design allows a working component (4) with a hexagonal rod part (41), as shown in FIGS. 5 and 6, to pass through the through hole (21) from the star-shaped opening (211). If the rod part (41) matches with or aligns with the hexagonal opening (212), it can pass through the through hole (21), forming a T-shaped wrench. Further, if the rod part (41) is rotated 30 degrees so that the rod part (41) of the hexagonal part (4) does not match with or align with the hexagonal opening (212), as shown in FIG. 7, the rod part (41) can enter the star-shaped opening (211) but cannot pass through the through hole (21). The C-clip (3) includes an arc segment (31) and a straight segment (32), wherein a part of the straight segment (32) is located inside the through hole (21). Therefore, the C-clip 3, located within the through hole (21), will apply a clamping force to the rod part (41) when the straight segment (32) is pushed outward by the rod part (41), such that the insertion of the rod part (41) is more stable. In this state, the invention functions as a socket extension wrench.

From the above content, it can be seen that by simply switching the combination mode of the ratchet (2) and the working component (4,) the wrench (1) can be switched, thereby reducing the total weight of wrenches that construction workers need to carry. This invention effectively addresses the common problem of excessive weight that construction workers have to bear when carrying wrenches and indeed has novelty and progressiveness.

Furthermore, the ratchet (2) includes a wide-diameter section (24) and a narrow-diameter section (25) which is formed integrally with the wide-diameter section (24). The through hole (21) extends through both the wide-diameter section (24) and the narrow-diameter section (25). The narrow-diameter section (25) is inserted into the head (11) of the wrench (1). The annular groove (22) is located at a position of the ratchet 2 where the side opening (23) communicates with the narrow-diameter section (25). A top and a bottom of the head (11) are located between the wide-diameter section (24) and the C-clip (3).

While we have shown and described the embodiment in accordance with the present invention, it should be clear to those skilled in the art that further embodiments may be made without departing from the scope of the present invention.

What is claimed is:

1. A ratchet wrench assembly, comprising:
a wrench (1) having a head (11) and a working part (12) respectively formed to two ends thereof;
a ratchet (2) installed within the head (11) of the wrench (1) and including a through hole (21), an annular groove (22) and a side opening (23), the side opening (23) defined in an inner bottom the annular groove (22), the through hole (21) communicating with the annular groove (22) via the side opening (23), one of two open ends of the through hole (21) being a star-shaped opening (211) with twelve points, each angle spaced 30 degrees apart, another one of the two open ends of the through hole (21) being a hexagonal opening (212) with six points, each angle spaced 60 degrees apart, the hexagonal opening (212) located corresponding to the star-shaped opening (211), and
a C-clip (3) engaged with the annular groove (22), a part of the C-clip (3) located in the side opening (23) located inside the through hole (21).

2. The ratchet wrench assembly as described in claim 1, wherein the ratchet (2) includes a wide-diameter section (24) and a narrow-diameter section (25) which is formed integrally with the wide-diameter section (24), the through hole (21) extends through both the wide-diameter section (24) and the narrow-diameter section (25), the narrow-diameter section (25) is inserted into the head (11) of the wrench (1), the annular groove (22) is located at a position of the ratchet 2 where the side opening (23) communicates with the narrow-diameter section (25), a top and a bottom of the head (11) are located between the wide-diameter section (24) and the C-clip (3).

3. The ratchet wrench assembly as described in claim 1, wherein the C-clip (3) includes an arc segment (31) and a straight segment (32), a part of the straight segment (32) is located inside the through hole (21).

4. A ratchet wrench assembly comprising:
a wrench (1) having a head (11) and a working part (12) respectively formed to two ends thereof;
a ratchet (2) installed within the head (11) of the wrench (1) and including a through hole (21), an annular groove (22) and a side opening (23), the side opening (23) defined in an inner bottom the annular groove (22), the through hole (21) communicating with the annular groove (22) via the side opening (23), one of two open ends of the through hole (21) being a star-shaped opening (211) with twelve points, each angle spaced 30 degrees apart, another one of the two open ends of the through hole (21) being a hexagonal opening (212) with six points, each angle spaced 60 degrees apart, the hexagonal opening (212) located corresponding to the star-shaped opening (211);
a C-clip (3) engaged with the annular groove (22), a part of the C-clip (3) located in the side opening (23) located inside the through hole (21), and
a working component (4) including a rod part (41) and a working head (42), a cross section of the rod part (41) is hexagonal, when the rod part (41) matches with the hexagonal opening (212), the rod part (41) is movable through the through hole (21), when the rod part (41) is inserted into the through hole (21) and is not matched with the hexagonal opening (212), the rod part (41) cannot pass through the through hole (21).

5. The ratchet wrench assembly as described in claim 4, wherein the ratchet (2) includes a wide-diameter section (24) and a narrow-diameter section (25) which is formed integrally with the wide-diameter section (24), the through hole (21) extends through both the wide-diameter section (24) and the narrow-diameter section (25), the narrow-diameter section (25) is inserted into the head (11) of the wrench (1), the annular groove (22) is located at a position of the ratchet 2 where the side opening (23) communicates with the narrow-diameter section (25), a top and a bottom of the head (11) are located between the wide-diameter section (24) and the C-clip (3).

6. The ratchet wrench assembly as described in claim 4, wherein the C-clip (3) includes an arc segment (31) and a straight segment (32), a part of the straight segment (32) is located inside the through hole (21).
